(19) United States
(12) Patent Application Publication
(10) Pub. No.: US 2020/0140076 A1
(43) Pub. Date: May 7, 2020

(54) HEATED CONTROL STICK

(71) Applicant: Bell Helicopter Textron Inc., Fort Worth, TX (US)

(72) Inventors: Chen Kuang, Montreal (CA); Paul Goyer, Sainte -Therese (CA)

(73) Assignee: Bell Helicopter Textron Inc., Fort Worth, TX (US)

(21) Appl. No.: 16/177,430

(22) Filed: Nov. 1, 2018

(51) Int. Cl. B64C 27/56; G05G 1/06; H05B 1/02; H05B 3/44

(52) U.S. Cl. CPC B64C 27/56; H05B 3/44; H05B 1/0236; G05G 1/06

(57) ABSTRACT

A series of heated control sticks for rotorcrafts, tiltrotors, and helicopters. The heated collective and cyclic sticks feature several heater assemblies to provide localized heating for pilots and co-pilots. The heater assemblies are formed from several layers of fabrics and resistive materials designed to generate heat while current is provided to conductive materials in the resistive material. A controller provides individualized control for users to adjust the temperature of various zones associated with either the collective stick or the cyclic stick. The heater assemblies can be installed entirely external to the stick like in a retrofit or partially internally.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Pilots and co-pilots endure low temperatures in aircraft resulting from inadequate environmental systems and extremely cold external temperature. Pilots and co-pilots can increase the amount of clothing they wear to keep warm. However, their hand typically are the least insulated because of the necessity to keep their hands in close contact with the aircraft and keep their hands flexible. Control elements, for example, cyclic sticks and collective sticks, can absorb the heat from the user's hand and create an unsafe environment for pilots and co-pilots flying in cold environments. Thick gloves and heated gloves reduce the user's ability to feel the controls in their hands. Thick gloves retain heat and heated gloves heat the user's hands regardless of location in the aircraft forcing the user to remove the glove to cool their hands. Additionally, heated air from the aircraft can be directed towards the control sticks, but since the control sticks move nearly constantly, the amount of heated air they receive varies greatly. Conventional systems to heat the hands of the pilot and the copilot while in contact with cyclic and collective sticks are inadequate.

### BRIEF DESCRIPTION OF THE DRAWINGS

FIG. 1 is a perspective view of a tiltrotor according to this disclosure.

FIG. 2 is a side view of a rotorcraft according to this disclosure.

FIG. 3 is a cross-sectional view of the rotorcraft of FIG. 2.

FIG. 4 is a perspective view of a heated cyclic stick according to this disclosure.

FIG. 5 is a cross-sectional view of the heated cyclic stick of FIG. 4.

FIG. 6 is a perspective view of a heated collective stick according to this disclosure.

FIG. 7 is a cross-sectional view of the heated collective stick of FIG. 6.

FIG. 8 is a perspective view of an alternative embodiment of a heated collective stick according to this disclosure.

FIGS. 9A-9C are schematic views of the heating elements in various configurations for heated control sticks according to this disclosure.

FIG. 10 is a schematic view of a heating element control system for heated control sticks according to this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure teaches a plurality of heaters for control elements of a rotorcraft. Pilots and co-pilots of aircraft are exposed to cold temperatures while flying. Supplying localized heating elements adjacent to the hands of pilots increases comfort and flexibility without weighing down the pilot's hands.

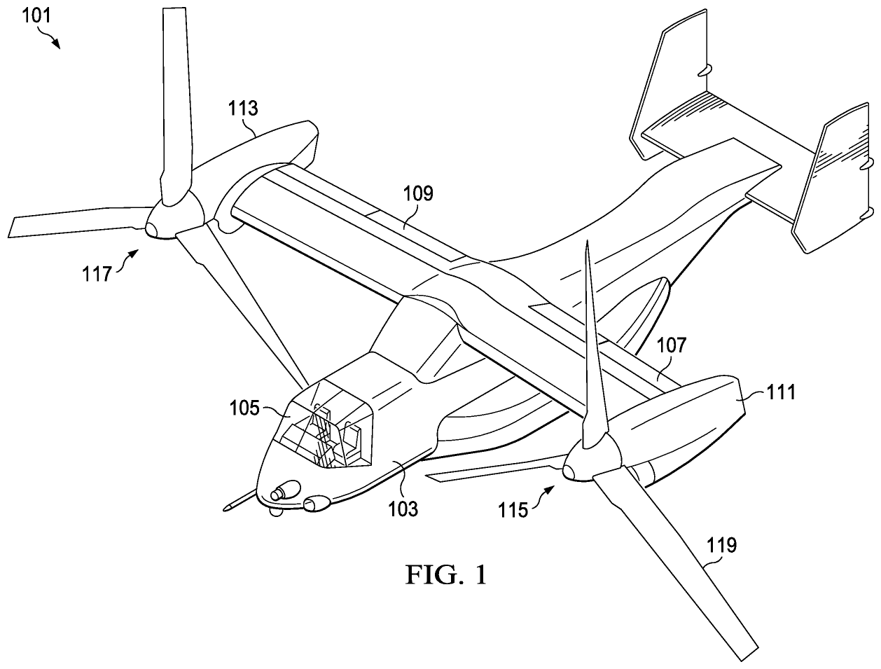

FIG. 1 illustrates a tiltrotor aircraft 101 equipped with a heated control stick according to this disclosure. Aircraft 101 has a fuselage 103 with a cockpit 105 located in a forward portion of fuselage 103. Wings 107, 109 are attached to fuselage 103, and an engine nacelle 111, 113 is rotatably attached to the outer end of each wing 107, 109, respectively. Each nacelle 111, 113 houses an engine (not shown), which is operably connected to a rotatable proprotor 115, 117. Each proprotor 115, 117 comprises three blades 119. Prop-rotors 115, 117 rotate in opposite directions and comprise similar components, though components in prop-rotors 115, 117 may be constructed and/or installed in a mirror, or reverse, manner from the opposite proprotor 115, 117.

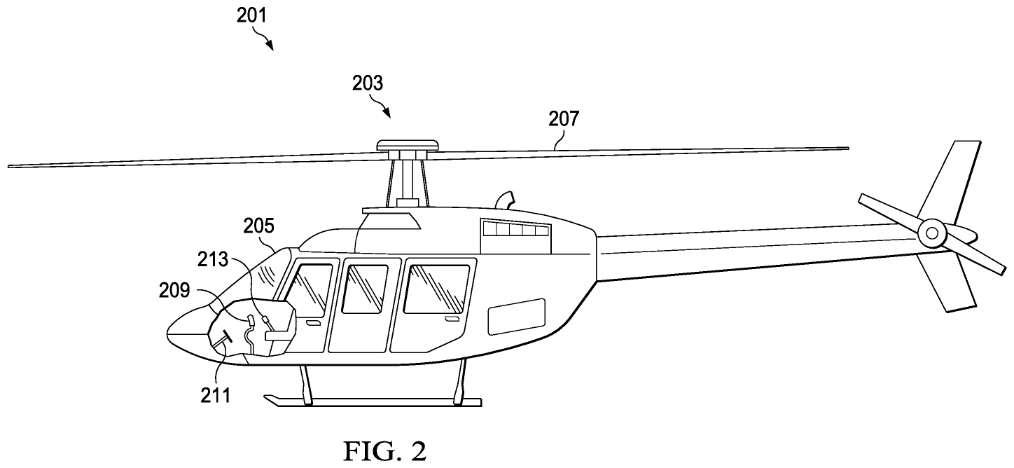

FIG. 2 illustrates a rotorcraft 201 equipped with a heated control stick according to this disclosure. Rotorcraft 201 comprises a rotor system 203 carried by a fuselage 205. One or more rotor blades 207 operably associated with rotor system 203 provide flight for rotorcraft 201 and are controlled with a plurality of control sticks within fuselage 205. For example, during flight a pilot can manipulate the heated cyclic stick 209 for changing the pitch angle of rotor blades 207, thus providing lateral and longitudinal flight direction, and/or manipulate pedals 211 for controlling yaw direction, furthermore the pilot can adjust the heated collective stick 213 thereby changing the pitch angles of all the rotor blades concurrently.

FIG. 3 illustrates a cockpit 301 of a rotorcraft comprising a heated co-pilot's collective stick 303, a heated co-pilot's cyclic stick 305, a set of co-pilot's pedals 307, a heated pilot's cyclic stick 309, and a controller 311. The pilot's collective stick is heated like the co-pilot's but is not shown in FIG. 3. The user switches the heat on and off as needed. Alternatively, the user can adjust a temperature setting of each heating element of each heated stick as needed to provide warmth to the user while in contact with the heated stick with controller 311.

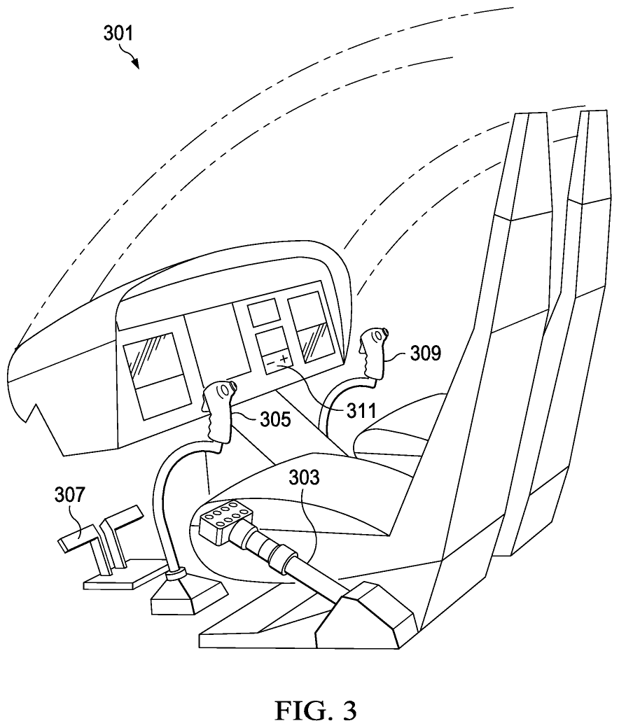

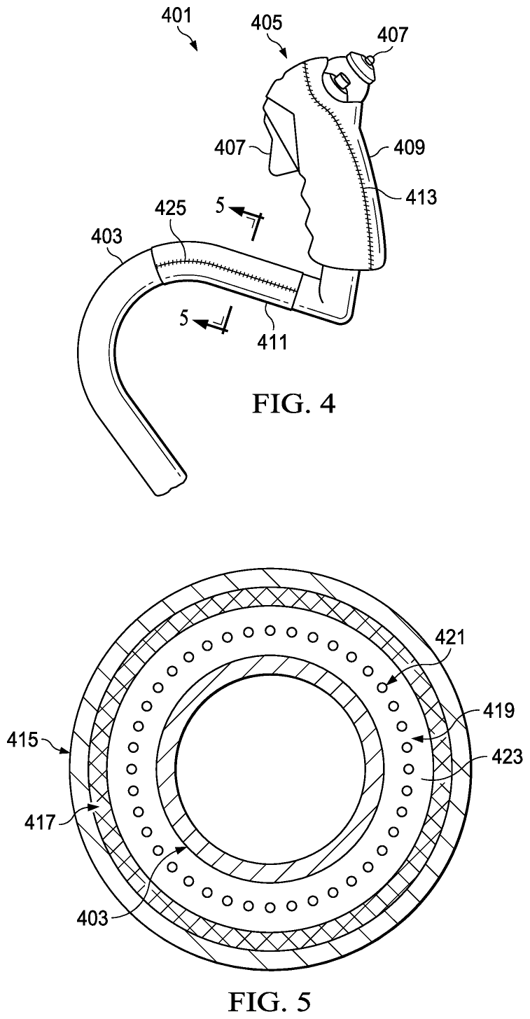

FIGS. 4 and 5 illustrate a heated cyclic stick 401 comprising a tubular member 403, a head member 405, a plurality of switches 407 located on the head member 405, a first heater assembly 409 partially covering the head member 405, and a second heater assembly 411 partially covering the tubular member 403. It should be apparent that more heaters may be located on the heated cyclic stick 401 as needed for heat output and cyclic stick configuration.

The first heater assembly 409 is comprised of a surface layer on top of a layer of nonwoven fabric covering a resistive layer that is in direct contact with an outside surface of the head member 405. Typically, the surface layer is comprised of leather. However, fabric, nylon, and other flexible and durable materials are suitable surface layers. Resistive layer is comprised of a conductive material carried by a flexible material. Heat is generated from the resistive layer, while current is applied to the conductive material. A first seam 413 is located on the first heater assembly 409, because the first heater assembly 409 is installed onto an assembled flight control element, and the first heater assembly 409 must be contoured and tight fitting to the assembled flight control element. The first seam 413 facilitates the tautness of the surface layer. An alternative embodiment features a surface layer or material that does not feature a seam.

FIG. 5 illustrates the structure of the second heater assembly 411. The second heater assembly 411 is comprised of an outer layer of surface material 415 located on top of a layer of nonwoven fabric 417 covering a resistive layer 419 that is in direct contact with an outside surface of the tubular member 403. Resistive layer 419 is comprised of a conductive material 421 embedded in a flexible material 423. Heat is generated from the resistive layer 419, while current is applied to the conductive material 421. A second seam 425 is located on the second heater assembly, because the second heater assembly 411 is installed onto an assembled flight control element, and the second heater assembly must be contoured and tight fitting to the assembled flight control element. The second seam 425 facilitates the tautness of the surface material. An alternative embodiment features a surface material that does not feature a seam.

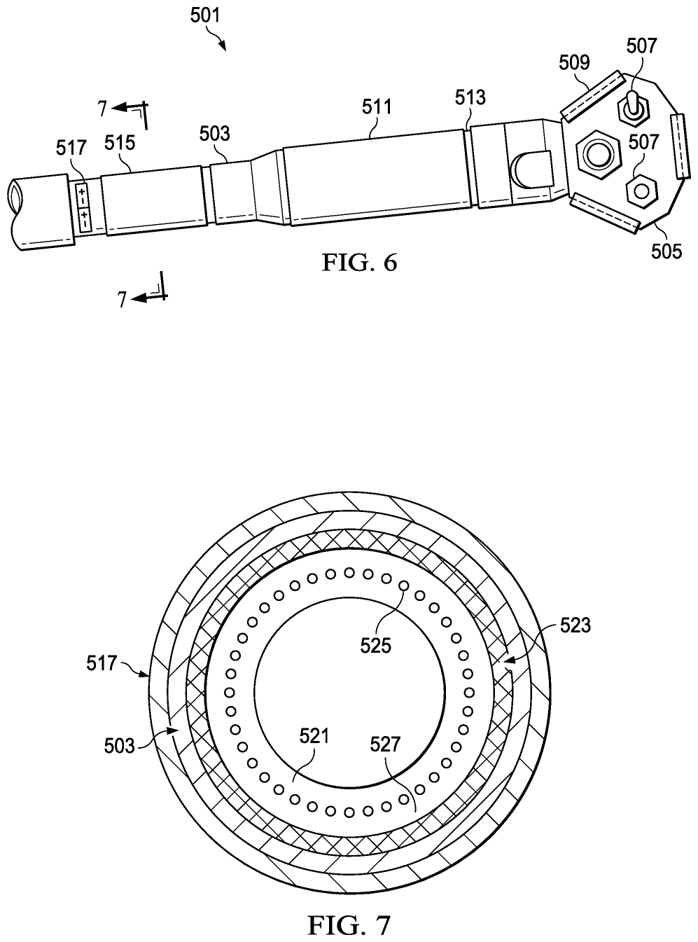

FIGS. 6 and 7 illustrate a heated collective stick 501 comprising a tubular member 503, a head member 505, a plurality of switches 507 located on the head member 505, a first heater assembly 509 partially covering the head member 505, a second heater assembly 511 covering a throttle control 513, a third heater assembly 515 partially covering the tubular member 503, and a controller 517. Control and power wiring (not shown) for the first heater assembly 509, the second heater assembly 511, and the third heater assembly 515 are routed through the center of the tubular member and connects the controller 517 to the various heaters located on the heated collective stick 501. The user can increase or decrease the amount of heat generated by the respective heater assembly by pressing plus or minus to adjust the temperature. While the controller as illustrated is located on the heated collective stick 501 other locations for the controller are contemplated, for example, the controller may be accessed centrally in a multi-function display or similar location. Switches on the controller 517 can be either physical buttons or integrated into the avionics system, for example in the multi-function display. Controllability can also vary from the “On/Off,” “Low/High/Off,” “Low/Mid/High/Off” as required by the users. Generally, the temperature of all the heaters will be synchronized and controlled together. Alternatively, the respective controls for each heating location are independent.

The first heater assembly 509 is planar and is comprised of an outer layer of surface material on top of a layer of nonwoven fabric covering a resistive layer that is in adhered with a planar outside surface of the head member 505 and is wrapped around a lower portion of the head member 505. Resistive layer is comprised of a conductive material carried by a flexible material. Heat is generated from the resistive layer, while current is applied to the conductive material. Typically an adhesive layer is used to attach the first heater assembly to the head member 505.

The second heater assembly 511 is comprised of an outer layer of surface material on top of a layer of nonwoven fabric covering a resistive layer that is adhered with an outside surface of the throttle control 513. Resistive layer is comprised of a conductive material carried by a flexible material. Heat is generated from the resistive layer, while current is applied to the conductive material. Typically, an adhesive layer is used to attach the second heater assembly to the throttle control 513.

FIG. 7 illustrates the structure of the third heater assembly 515. The third heater assembly 515 is comprised of an outer layer of surface material 519 located on top of the tubular member 503, outside the tubular member 503 is a resistive layer 521 that is separate from an exterior surface of the tubular member 503 by a layer of nonwoven fabric 523. Resistive layer 521 is comprised of a conductive material 525 embedded in a flexible material 527. Heat is generated from the resistive layer 521, while current is applied to the conductive material 525. This embodiment features a surface material 519 that does not feature a seam. Seamless embodiments are suitable based upon the design and installation approach of the heater assembly.

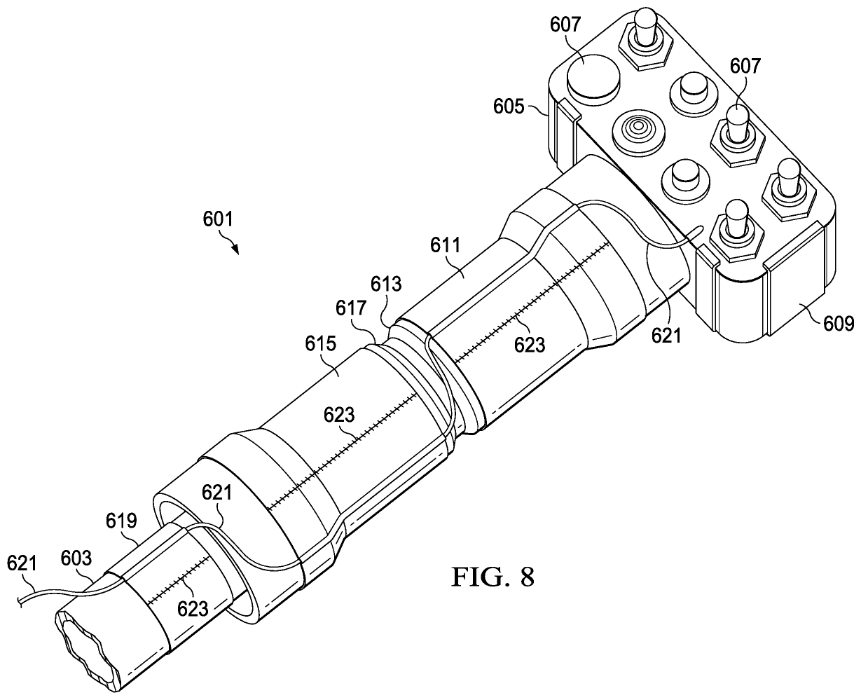

Referring now also to FIG. 8, FIG. 8 illustrates a heated collective stick 601 comprising a tubular member 603, a head member 605, a plurality of switches 607 located on the head member 605, a first heater assembly 609 partially covering multiple surfaces of the head member 605, a second heater assembly 611 covering a first throttle control 613, a third heater assembly 615 covering a second throttle control 617, and a fourth heater assembly 619 partially covering the tubular member 603. Control and power wiring 621 for the first heater assembly 609, the second heater assembly 611, the third heater assembly 615, and the fourth heater assembly 619 are routed externally of the tubular member. Externally routing the wires precludes interfering with existing wiring and controls located inside the tubular member 603, thereby allowing the system to be retrofitted to an existing assembled collective stick. Alternatively, the wiring between heater assemblies can be located inside the tubular member to reduce cabin interference between external wiring, the pilots, and the heated collective stick 601. Furthermore, each heater assembly features an input and an output node for power and control to be routed through the heater assembly, thereby allowing the heater assemblies to be chained together electrically.

The heater assemblies 609, 611, 615, 619 are comprised of an outer layer of surface material on top of a nonwoven fabric layer covering a heat resistive layer that is in direct contact with a surface to be heated. Heat resistive layer is comprised of a conductive material carried by a flexible material. Heat is generated from the heat resistive layer, while current is applied to the conductive material. Seams 623 facilitates tautness of the surface material and allows the heater assemblies to be retrofitted to an existing control element. For the heater assembly 611 on the collective throttle, additional seams can be utilized to tighten the surface material and ensure the pilot's throttle movement won't get disturbed by the additional surface material. Alternatively, the heater assembly is manufactured concurrently with the control element so that the conductive material is embedded into the grips, tubular material, and control heads as needed.

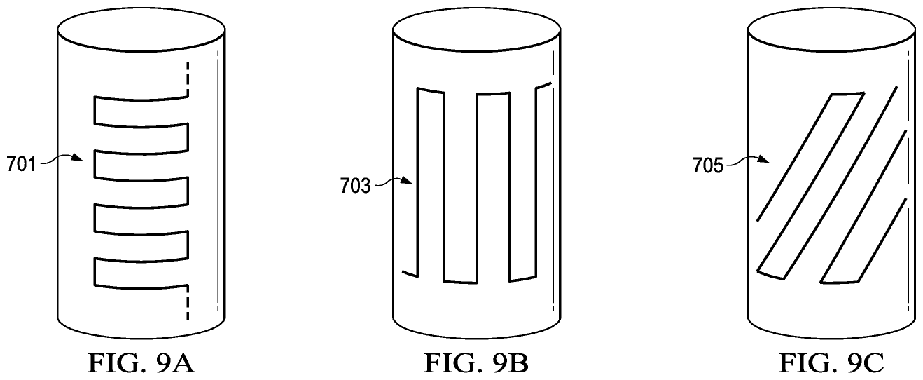

FIGS. 9A-9C illustrates the structure of the conductive materials carried by a flexible material. Control elements such as cyclic sticks and collective sticks are complicated structures to cover with a layer of conductive materials. FIG. 9A illustrates a pattern where the conductive element 701 is horizontally aligned to the tubular member. FIG. 9A illustrates an alignment suitable for covering bending tubular members in a single curving axis, such as a cyclic stick. FIG. 9B illustrates a pattern where the conductive element 703 is vertically aligned to the tubular member. FIG. 9B illustrates an alignment suitable for covering straight tubular members, such as a collective stick. FIG. 9C illustrates a pattern where the conductive element 705 is diagonally aligned to the tubular member. FIG. 9C illustrates an alignment suitable for covering head members that feature multiple bends in several directions.

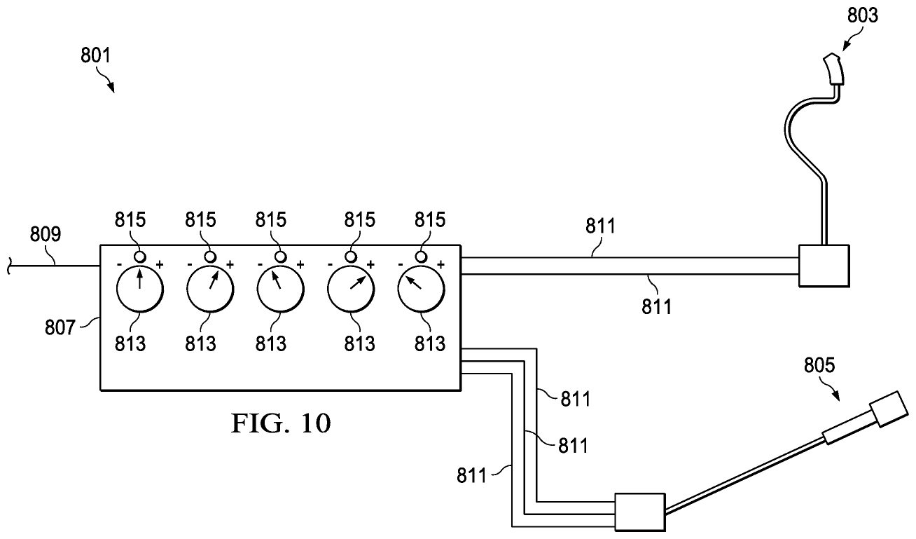

FIG. 10 illustrates a control system for a cockpit featuring a heated collective stick and a heated cyclic stick. Heating system 801 is comprised of a heated cyclic stick 803, a heated collective stick 805, and a controller 807. As described above, the heated collective stick 805, like heated collective stick 501, comprises a first heater located on a head of the collective stick, a second heater located on a throttle control, and a third heater located on a tubular member. Each heater on the heated collective stick 805 can be individually controlled and wired independently. As described above, the heated cyclic stick 803, like heated cyclic stick 401, comprises a first heater located on a head of the cyclic stick and a second heater located on a tubular member. Each heater on the heated cyclic stick 803 can be individually controlled and wired independently.

Controller 807 is comprised of a power input 809, a plurality of power outputs 811, a plurality of switches 813, and a plurality of lighting elements 815. Each of the plurality of power outputs 811 is wired to one of the heaters and controlled by one of the plurality of switches 813. The user can adjust a knob of the corresponding switch 813 and vary the level of heat emitted from the corresponding heater. For example, a pilot could maximize heat from an entire cyclic stick and have no heat from a collective throttle heater. Corresponding to each switch of the plurality of switches 813 is a lighting element of the plurality of lighting elements 815. Typically, the lighting element is a multi-colored light emitting diode so that the user can see conditional information regarding the heater assemblies. For example, a green colored light would indicate a working heater, and a red colored light would indicate a failure. Other colors of the light emitting diode are contemplated, such as yellow to indicate approaching the targeted temperature. Furthermore, the conditional information can be transmitted across a data bus to other flight computers for display on multi-function displays.

The controller 807 can be distributed into several units spread out across the control elements, for example, located on each stick. Alternatively, the controller 807 can control heaters for multiple sticks and multiple users, for example, a single controller can control stick temperatures for both pilot and co-pilot. Alternatively, the controller 807 can be incorporated into flight control computers and environmental control units to coordinate control of the various heaters for the various sticks with other rotorcraft control systems. Furthermore, an alternative embodiment features thermocouples located in each of the heater assemblies. The thermocouples being wired to the controller and provide a feedback loop for each heater assembly.

It should be noted that the heated control stick system provides users with the ability to warm the control sticks to a comfortable level. The heated control stick system does not weigh down the user's hand with extra material as thick gloves do. The heated control stick system is adjustable so that each user can vary the desired warmth of each isolated area.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ-Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A heated control stick for a rotorcraft, the heated control stick comprising:
a tubular member;
a first heater assembly partially covering the tubular member; and
a controller configured for varying a temperature of the first heater assembly.

2. The heated control stick of claim 1, further comprising:
a head member having an at least one switch, the head member located on an end of the tubular member; and
a second heater assembly partially covering the head member;
wherein the controller is configured for varying a temperature of the second heater assembly.

3. The heated control stick of claim 2, further comprising:
a first throttle control located between the tubular member and the head member; and
a third heater assembly partially covering the first throttle control;
wherein the controller is configured for varying a temperature of the third heater assembly.

4. The heated control stick of claim 3, further comprising:
a second throttle control located between the first throttle control and the head member; and
a fourth heater assembly partially covering the second throttle control;
wherein the controller is configured for varying a temperature of the fourth heater assembly.

5. The heated control stick of claim 2, wherein the heated control stick is a cyclic control stick.

6. The heated control stick of claim 3, wherein the heated control stick is a collective control stick.

7. The heated control stick of claim 2, wherein the second heater assembly is planar.

8. The heated control stick of claim 1, the first heater assembly comprising:
a heat resistive layer;
a fabric layer; and
a surface material layer;
wherein the heat resistive layer is external to the tubular member.

9. The heated control stick of claim 2, wherein the second heater assembly covers multiple surfaces of the head member.

10. The heated control stick of claim 1, the first heater assembly comprising:
a heat resistive layer;
a fabric layer; and
a surface material layer;
wherein the heat resistive layer is internal to the tubular member.

11. The heated control stick of claim 8, the first heater assembly further comprising:
a seam located in the first heater assembly.

12. The heated control stick of claim 1, wherein the controller is located on the heated control stick.

13. The heated control stick of claim 1, wherein the controller is located external to the heated control stick.

14. The heated control stick of claim 3, wherein the first heater assembly is directly wired to only the controller and the third heater assembly; and
wherein the second heater assembly is only wired directly to the third heater assembly.

15. The heated control stick of claim 1, wherein the controller is illuminated with a plurality of light elements configured for displaying a status of the first heater assembly.

16. A rotorcraft having a rotor system comprising a plurality of rotor blades, the rotorcraft comprising:
a heated cyclic stick having;
at least one heater assembly located on the heated cyclic stick;
wherein the heated cyclic stick is configured for varying a pitch of at least one blade of the rotor system.

17. The rotorcraft of claim 16, further comprising:
a heated collective stick having;
an at least one heater assembly located on the heated collective stick.

18. The rotorcraft of claim 16, wherein the at least one heater assembly is located on a head member of the heated cyclic stick.

19. A method of heating a control stick for a rotorcraft comprising:
locating an at least one heater assembly on the control stick; and
varying a temperature of the at least one heater assembly.

20. The method of claim 19, further comprising:
retrofitting the control stick so that any internal elements of the control stick are unaffected by the retrofitting.
